(19) United States
(12) Patent Application Publication
(10) Pub. No.: US 2006/0280853 A1
(43) Pub. Date: Dec. 14, 2006

(54) Method of preparing a cheese flan

(76) Inventor: Candido Salmon Garcia De Los Salmones, Cantabria (ES)

Correspondence Address: BROWN & MICHAELS, PC;400 M & T BANK BUILDING, 118 NORTH TIOGA ST, ITHACA, NY, 14850, US

(21) Appl. No.: 10/554,613

(22) PCT Filed: Apr. 24, 2004
(86) PCT No.: PCT/ES04/70025

§ 371 Date: Oct. 27, 2005

(30) Foreign Application Priority Data
Apr. 30, 2003 (ES) P200300998

(51) Int. Cl. A23C 19/00

(52) U.S. Cl. 426/582; 426/580

(57) ABSTRACT

A process for preparing a cheese flan comprising the preparation of a mixture from milk, sugar, unripened cream cheese and liquid egg, flavoured with cinnamon and lemon rind, the linear dosing of the mixture obtained and liquid caramel in a vacuum sealed container; and baking of the product by pasteurization in the container itself, with a final cooling of the product at a preservation temperature comprised between 0° and 8° C.

### OBJECT OF THE INVENTION

The present invention, as stated by its title, refers to a process for preparing a flan which has the particularity of having added cream cheese, as well as the product obtained by said process.

### BACKGROUND OF THE INVENTION

Flan is a product obtained by mixing milk and whisked eggs, to which sugar, or sweetener when making a low-calorie flan, and some other types of flavourings are added. The mixture is arranged in a container in which caramelised sugar has been placed and it is then baked in a water bath.

Spanish patent document ES 2142940 refers to a method for producing a milk-based non-acidified edible gel and the use of this gel, which has the particularity of having transglutaminase added to the milk of human origin at a ratio comprised between 0.1 and 0.5%.

Spanish patent document ES 2164178 refers to a process for preparing in this case a chocolate flan following the traditional method.

### DESCRIPTION OF THE INVENTION

The process described herein comprises a first preparation phase of a milk-based dairy product mixture, to which liquid egg, sugar and flavourings such as cinnamon and/or lemon rind are added together with unripened cream cheese, which is the product that provides it with organoleptic qualities distinguished by their fine and light qualities. The milk or dairy product may be whole, skimmed, cream or powdered milk and must be of animal origin with a fat content comprised between 0 and 50% of the original.

It is possible, when trying to achieve a flan with different flavours, for example coffee or chocolate, to add to this mixture a percentage of 2% of soluble coffee and/or 10% of pure dark chocolate coating, with which a coffee or chocolate flavoured flan is obtained, or with other flavours in similar proportions.

The mixture thus obtained is dosed in individual containers together with liquid caramel, which containers will subsequently be vacuum sealed and subjected to a baking process by pasteurization in the container itself, with subsequent cooling of the product to a preservation temperature comprised between 0 and 8° C.

The product thus obtained has the consistency and general appearance of a flan in which the following products are present in the following ratios:

| | |
|---|---|
| Milk | 50-60% |
| Unripened cheese | 12-18% |
| Liquid egg | 14-20% |
| Sugar | 12-15% |
| Cinnamon | 0.8-1.3% |
| Lemon rind | 0.4-1.5% |
| Liquid caramel | 5-8% |

In the coffee flavoured cheese flan variant soluble coffee is added in a percentage comprised between 2% and 3%. When it is a chocolate flavoured flan a pure dark chocolate coating is added between 10% and 12%. An alternative variant implies adding other flavours with similar percentages.

### PREFERRED EMBODIMENT OF THE INVENTION

In an embodiment for obtaining 1000-1020 cheese flan containers with an approximate content of 100-115 g each, this is achieved from a vat with sufficient capacity as to contain 65 litres of skimmed cow milk flavoured with 125 g of cinnamon and 0.55 kg of lemon rind, to which unripened cream cheese in a proportion of 15 kg, 20 kg of liquid egg, 14 kg of sugar or another sweetener in the same proportion are added, mixed by mechanical means for 30 minutes. Then and in a packaging machine the latter is fed into about 1000 containers with an approximate capacity of 0.12 litres each, on which 6 kg of liquid caramel and the approximately 117 kg of the previously obtained mixture are dosed linearly and in the adequate proportion, until filling each container, and then vacuum-sealing them. Between 1000 and 1020 containers are obtained which are subjected to a pasteurization process in a machine suitable for this purpose, heating them at a temperature comprised between 70° and 105° C. for a time period comprised between 25 and 35 minutes; they are subsequently packaged and preserved in a refrigerator at a temperature comprised between 0° and 8° C.

The inclusion of liquid caramel is optional, a cheese flan with or without caramel being able to be obtained by the same process.

It is possible to obtain by the same process flan with other added flavours, for example coffee or chocolate, by adding to this mixture a percentage between 2% and 3% of soluble coffee and/or between 10% and 12% of pure dark chocolate coating, with which a coffee or chocolate or other flavoured flan is obtained, for example vanilla flavour, with similar percentages.

1. A process for preparing a cheese flan, characterised in that it comprises: a first preparation phase for preparing a mixture from milk, sugar, unripened cheese and liquid egg, flavoured with cinnamon and lemon rind; a second preparation phase for the linear dosing of the mixture obtained and liquid caramel in a container in the chosen format, which is vacuum sealed once filled; and a third product baking phase for baking the product in its own container by pasteurization, which container is subjected to a temperature between 70° and 105° C. for a period comprised between 25 and 35 minutes, and final cooling of the product at a preservation temperature comprised between 0° and 8° C.

2. A process for preparing a cheese flan according to claim 1, characterised in that the flan obtained includes the following products in the following percentage margin ratios: 50-60% milk, 12-18% unripened cheese, 14-20% liquid egg, 12-15% sugar, 0.8-1.3% cinnamon, 2-3% lemon rind and 5-8% liquid caramel.

3. A process for preparing a cheese flan according to claim 1, characterised in that the flan obtained includes soluble coffee in a percentage comprised between 2% and 3%.

4. A process for preparing a cheese flan according to claim 1, characterised in that the flan obtained includes, a pure dark chocolate coating in a percentage comprised between 10% and 12%.

5. A process for preparing a cheese flan according to claim 1, characterised in that the flan obtained includes other flavours, such as vanilla.

6. A cheese flan made by the process comprising the steps of:
a) preparing a mixture of milk, sugar, unripened cheese, and liquid egg, flavoured with cinnamon and lemon rind;
b) linearly dosing the mixture of step a) with liquid caramel in a container which is vacuum sealed once filled;
c) baking the mixture in the container by pasteurization, wherein the container is subject to a temperature between 70° and 105° C., for a period between 25 to 35 minutes, and
d) cooling of the mixture in the container at a preservation temperature between 0° and 8° C.

7. The cheese flan of claim 6, wherein the mixture includes the following percentage margin ratios: 50-60% milk, 12-18% unripened cheese, 14-20% liquid egg, 12-15% sugar, 0.8-1.3% cinnamon, 2-3% lemon rind and 5-8% liquid caramel.

8. The cheese flan of claim 6, wherein the mixture further comprises soluble coffee in a percentage between 2% and 3%.

9. The cheese flan of claim 6, wherein the mixture further comprises a pure dark chocolate coating in a percentage comprised between 10% and 12%.

10. The cheese flan of claim 6, wherein the flan includes other flavours such as vanilla.
